(19) United States
(12) Patent Application Publication
(10) Pub. No.: US 2007/0115262 A1
(43) Pub. Date: May 24, 2007

(54) Apparatus and method for inputting characters in mobile communication terminal

(75) Inventor: Byoung-Seoup Moon, Suwon-si (KR)

Correspondence Address: DILWORTH & BARRESE, LLP, 333 EARLE OVINGTON BLVD., SUITE 702, UNIONDALE, NY, 11553, US

(73) Assignee: Samsung Electronics Co., Ltd., Suwon-si (KR)

(21) Appl. No.: 11/603,875

(22) Filed: Nov. 22, 2006

(30) Foreign Application Priority Data
Nov. 24, 2005 (KR) 2005-0112651

(51) Int. Cl. G09G 5/00

(52) U.S. Cl. 345/169

(57) ABSTRACT

Provided is an apparatus and method for inputting characters in a mobile communication terminal in which at least one character is mapped to each key An input key including a desired character is selected, a sequence key corresponding to the mapping sequence of the desired character is selected, and the character designated by the selected sequence key is displayed. Accordingly, it is possible to conveniently input the desired key by pressing only two keys, i.e., the input key and the sequence key, without having to press a separate key or wait for a predetermined time after pressing the input key.

### PRIORITY

This application claims priority under 35 U.S.C. § 119 to an application entitled “Apparatus And Method For Input Character Portable Terminal” filed in the Korean Intellectual Property Office on Nov. 24, 2005 and assigned Serial No. 2005-112651, the contents of which are incorporated herein by reference.

### BACKGROUND OF THE INVENTION

1. Field of the Invention

The present invention relates generally to an apparatus and method for inputting characters in a mobile communication terminal, and in particular, to an apparatus and method for inputting characters in a mobile communication terminal, which makes it possible to efficiently input a plurality of characters contained in one keybutton.

2. Description of the Related Art

Mobile communication terminals are highly portable, and their use is rapidly increasing. Accordingly, communication service providers and communication terminal manufacturers are competitively developing mobile communication terminals with more convenient functions in order to attract more users.

For example, current mobile communication terminals provide a variety of additional functions such as phone book, game, scheduler, morning call, MP3 (MPEG Layer 3) and digital camera functions. These terminals also provide services such as short message, multimedia message, cell broadcasting, Internet and e-mail services.

Recently, the short message, multimedia message, e-mail and cell broadcasting services have been used more frequently than a call function, which increases the input amount of characters for the messages.

In a conventional character input method, a plurality of characters are mapped to one keybutton and are sequentially inputted according to the number of times the user presses the keybutton.

When a user wants to successively input two characters mapped into one of the keybuttons, the user must additionally press a navigation keybutton or wait for a predetermined time after input of the first character by pressing the keybutton.

As described above, in the conventional character input method, a plurality of characters are mapped into one keybutton and are sequentially inputted according to the number of times the user presses the keybutton. However, as the number of characters mapped into each keybutton increases, the number of keybutton presses necessary to input a character increases. Moreover, a separate keybutton (e.g., the navigation keybutton) must be additionally pressed to successively input two or more characters mapped into the keybutton.

### SUMMARY OF THE INVENTION

An object of the present invention is to substantially solve at least the above problems and/or disadvantages and to provide at least the advantages below. Accordingly, an object of the present invention is to provide an apparatus and method for inputting characters in a mobile communication terminal, which makes it possible to efficiently input a plurality of characters contained in one keybutton.

Another object of the present invention is to provide an apparatus and method for inputting characters in a mobile communication terminal, which makes it possible to efficiently input characters by using input keys containing a plurality of characters and sequence keys that are mapped in one-to-one correspondence with the characters in the input key to select one of the characters.

According to the present invention, in a method for inputting characters in a mobile communication terminal in which at least one character is mapped to each key, characters mapped to an inputted key are detected. It is determined whether a sequence key for selecting one of the detected characters is inputted. When the sequence key is inputted, the character designated by the selected sequence key is displayed.

According to the present invention, an apparatus for inputting characters in a mobile communication terminal in which one or more characters are mapped to each key includes a keypad and a controller. The keypad is configured to input an input key and sequence keys. The controller selects a character mapped to the sequence key among characters mapped to the input key.

### BRIEF DESCRIPTION OF THE DRAWINGS

The above and other objects, features, and advantages of the present invention will become more apparent from the following DETAILED DESCRIPTION when taken in conjunction with the accompanying drawings in which:

FIG. 1 is a block diagram of a mobile communication terminal according to the present invention;

FIG. 2 illustrates a keypad for inputting characters in a mobile communication terminal according to the present invention;

FIG. 3 is a flowchart illustrating a procedure for inputting characters in a mobile communication terminal according to the present invention; and

FIGS. 4A and 4B illustrate the configuration of display screens for inputting characters in a mobile communication terminal according to the present invention.

### DETAILED DESCRIPTION OF THE PREFERRED EMBODIMENTS

Preferred embodiments of the present invention will be described herein below with reference to the accompanying drawings. In the following description, well-known functions or constructions are not described in detail for the sake of clarity and conciseness.

The present invention provides a technique for efficiently inputting characters by using input keys containing a plurality of characters and sequence keys that are mapped in one-to-one correspondence with the characters in the input key to select one of the characters.

The input key denotes 3×4 keys each containing a plurality of characters, and the sequence keys may be set suitably. The following description will be made of a preferred embodiment in which numeric keys 1, 2, 3 and 4 are set to the above sequence keys.

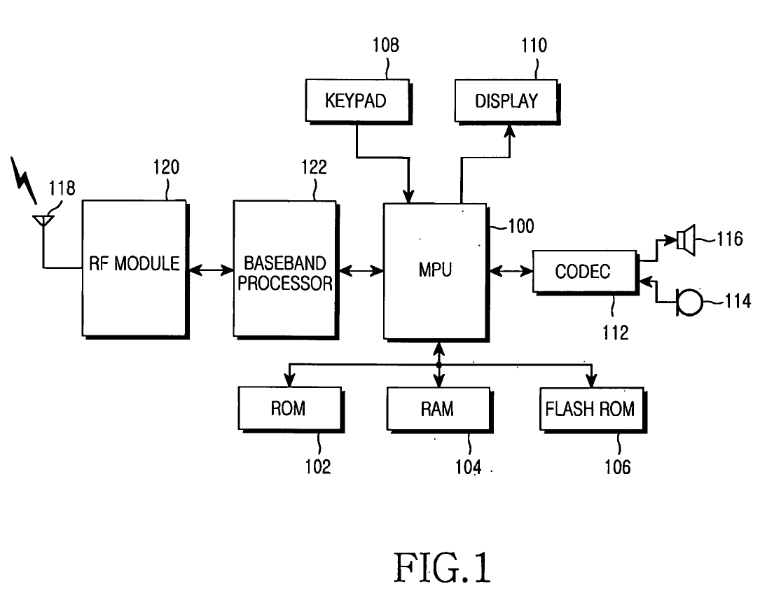

FIG. 1 is a block diagram of a mobile communication terminal according to the present invention. The mobile communication terminal includes a cellular phone, a personal communication system (PCS) terminal, a personal data assistant (PDA) and an international mobile communication 2000 (IMT-2000) terminal. The following descriptions will be made with a general structure of the above terminal.

Referring to FIG. 1, the mobile communication terminal includes a controller (e.g., an MPU) 100, a read only memory (ROM) 102, a random access memory (RAM) 104, a flash ROM 106, a keypad 108, a display unit 110, a coder-decoder (CODEC) 112, a microphone 114, a speaker 116, an antenna 118, a radio frequency (RF) module 120 and a baseband processor 122.

The controller 100 controls an overall operation of the mobile communication terminal. For example, the controller 100 processes and controls voice and data communication. In addition to the general functions, the controller 100 selects, from a plurality of characters selected by input keys, one character to be inputted according to input of a sequence key. A detailed description about the general control operation of the controller 100 will be omitted for conciseness.

The ROM 102 stores a variety of reference data and microcodes of a program for the process and control operation of the controller 100. According to the present invention, the ROM 102 stores a program for selecting, from a plurality of characters selected by an input key, one character according to input of a sequence key. The RAM 104 is a working memory of the controller 100, which stores temporary data that is generated during the execution of various programs. The RAM 104 temporarily stores key data that is sequentially mapped in one-to-one correspondence with a plurality of characters in the input key. The flash ROM 106 stores a variety of updatable data such as a phone book, an outgoing message and an incoming message. The flash ROM 106 stores a representative character representing a plurality of characters contained in each input key.

The keypad 108 includes numeric keybuttons of digits 0-9 and a plurality of function keybuttons such as Menu, Cancel (delete), Confirmation, Talk, End, Internet connection, Navigation (▴/▾/ [symbol] / [symbol] ) and character input keybuttons. The keypad 108 provides the controller 100 with key input data that corresponds to a keybutton pressed by a user.

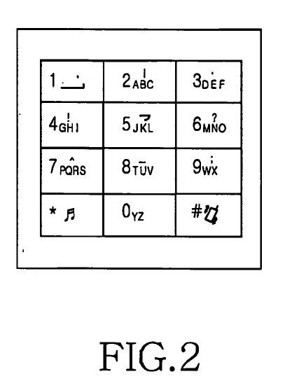

As illustrated in FIG. 2, the keypad 108 includes a plurality of keybuttons and a plurality of sequence keys. Each of the keybuttons contains a plurality of characters, and the sequence keys are used to select one of a plurality of characters selected by each of the keybuttons.

Touch pad may used as an input means. In this case touch pad includes a plurality of touching elements for inputting characters, numerals and directional function. Here, each touching element is corresponding to each key of the key pad.

The display unit 110 displays status information generated during operations, numerals and characters, moving and still pictures, and other information. The display unit 110A may be a color liquid crystal display (LCD). The display unit 110 displays numerals or characters (e.g., English capital/small letters and Korean consonants and vowels) selected by the numeric keybuttons of the keypad 108.

The CODEC 112 connected to the controller 100, the speaker 116 and the microphone 114 connected to the CODEC 112 constitute an audio input/output block that is used for telephone communication and voice recording. The CODEC 112 converts PCM data received from the controller 100 into analog audio signals and outputs the analog audio signals to the speaker 116. Also, the CODEC 112 converts audio signals received through the microphone 114 into PCM data and provides the PCM data to the controller 100.

The RF module 120 down-converts an RF signal received through the antenna 118 and provides the resulting baseband signal to a baseband processor 122. Also, the RF module 120 up-converts a baseband signal provided from the baseband processor 122 and transmits the resulting RF signal through the antenna 118. The baseband processor 122 processes the baseband signals that are exchanged between the RF module 120 and the controller 100. For example, in the case of data transmission, the baseband processor 122 performs channel coding and spreading on data to be transmitted. In the case of data reception, the baseband processor 122 performs despreading and channel decoding on received data.

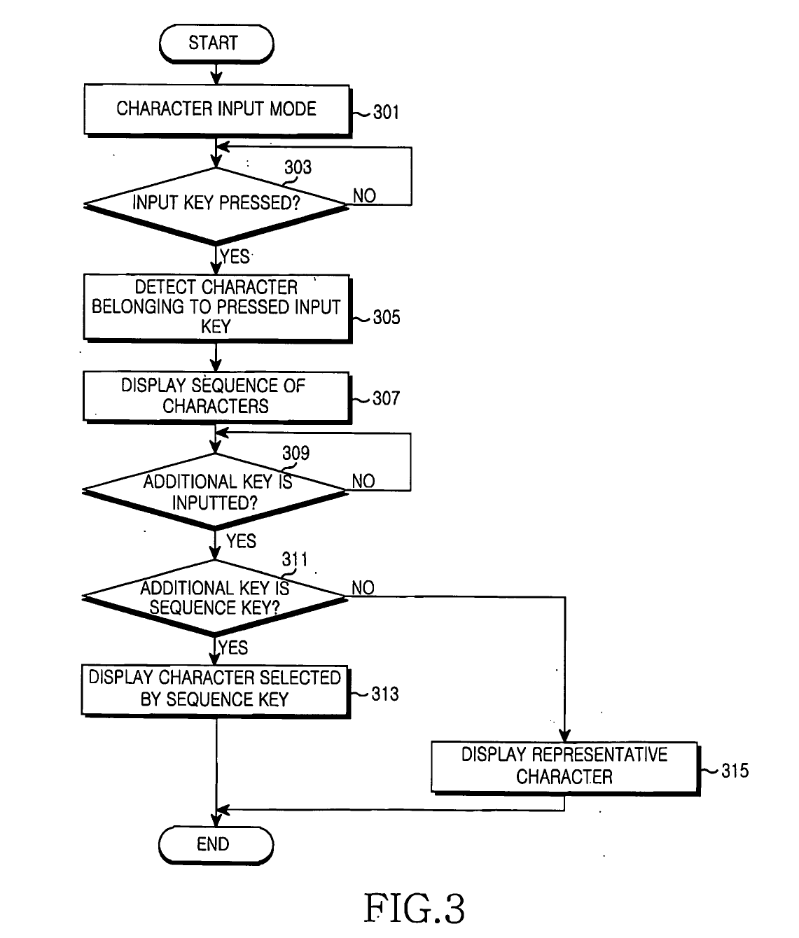

FIG. 3 is a flowchart illustrating a procedure for inputting characters in a mobile communication terminal according to the present invention.

Referring to FIG. 3, a character input mode for inputting characters is initiated in step 301. In step 303, the controller 100 determines whether an input key is pressed. If an input key is pressed, the controller 100 proceeds to step 305, and if not, the controller 100 performs step 303 again.

In step 305, the controller 100 detects characters belonging to the pressed input key, and temporarily stores the detected characters in the RAM 104 in such a manner that the detected characters are mapped in one-to-one correspondence with sequence keys.

In step 307, the controller 100 sequentially displays the detected characters and the corresponding sequence keys at predetermined positions on a screen of the display unit 110.

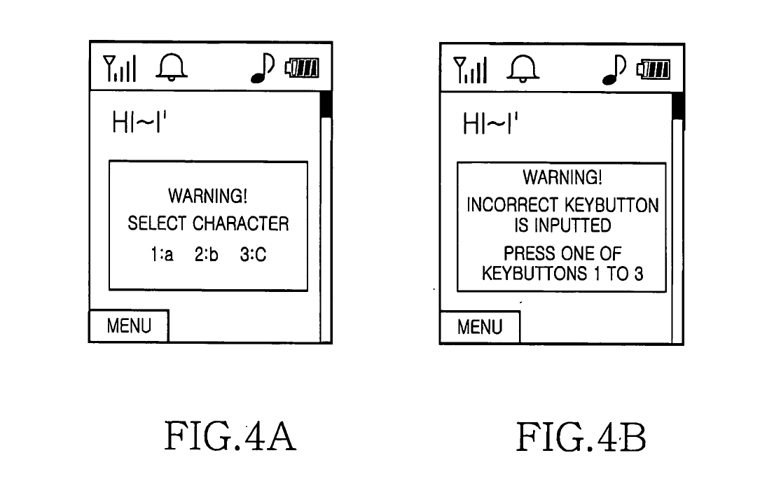

For example, when the second numeric key 2 of FIG. 2 is selected as the sequence key, the controller 100 ascertains that three characters a, b and c belong to the second numeric key 2, and sequentially numbers and displays the characters a, b and c, as illustrated in FIG. 4A (e.g., 1:a, 2:b, 3:c).

In step 309, the controller 100 determines whether an additional key is pressed by the user. If an additional key is pressed, the controller 100 proceeds to step 311, and if not, the controller 100 performs step 309 again.

In step 311, the controller 100 determines whether the additionally pressed key is the prior key for selecting one of the characters mapped to the input key. If the additionally pressed key is the prior key, the controller 100 proceeds to step 313, and if not, the controller 100 proceeds to step 315.

When numeric keys 1, 2, 3 and 4 are used as the prior keys and the second numeric key 2 of FIG. 2 is selected, the numeric keys 1, 2 and 3 are set respectively to three characters a, b and c contained in the second numeric key 2. On the other hand, when the seventh numeric key 7 of FIG. 2 is selected, the numeric keys 1, 2, 3 and 4 are set respectively to four characters p, q, r and s contained in the seventh numeric key 7.

In step 313, among the numbered and displayed characters, the controller 100 displays the character selected by the prior key.

For example, when the second numeric key 2 of FIG. 2 was inputted, thus displaying ‘1:a and then 2:b, 3:c’, when the third numeric key 3 is pressed by the user, the third character ‘c’ is displayed on the display unit 110.

Thereafter, the controller 100 ends the character inputting procedure.

In step 315, the controller 100 displays the character that is designated as the representative of the numbered and displayed characters.

For example, when the second numeric key 2 was inputted, thus displaying ‘1:a and then 2:b, 3:c’ as illustrated in FIG. 4A, when the fourth numeric key 4 is inputted by the user, the representative (e.g., ‘a’) of the characters a, b and c is displayed because the second numeric key 2 has only three characters.

At this point, the representative character can be changed according to the user's preference.

Alternatively, as illustrated in FIG. 4B, unlike FIG. 4A, when the key pressed after the input key is not the prior key, the controller 100 may display a warning message for warning that the additionally-pressed key fails to indicate the sequence of the characters contained in the input key.

Thereafter, the controller 100 ends the character inputting procedure.

As described above, the input key containing a desired character is inputted and the sequence key is inputted to select the desired character from characters belonging to the input key. Accordingly, it is possible to conveniently input the desired key by pressing only two keys, i.e., the input key and the sequence key, without having to press a separate key or wait for a predetermined time after pressing the input key.

While the present invention has been shown and described with reference to certain preferred embodiments thereof, it will be understood by those skilled in the art that various changes in form and details may be made therein without departing from the spirit and scope of the present invention as defined by the appended claims.

What is claimed is:

1. A method for inputting characters in a mobile communication terminal having a plurality of keys, in which at least one character is mapped to each key, the method comprising the steps of:
selecting a key including a desired character;
selecting a sequence key corresponding to the desired character; and
displaying the character designated by the selected sequence key.

2. The method of claim 1, wherein a key corresponding to the sequence key is mapped to a separate key or to the key including the desired character.

3. The method of claim 1, wherein the key including the mapped character is displayed on a display unit of the mobile communication terminal using an on-screen keyboard, and the sequence key is changeable by a user's selection.

4. The method of claim 1, further comprising displaying a representative of characters included in the selected key, when a key other than the sequence key is inputted.

5. The method of claim 4, wherein the representative character is designated by a user.

6. The method of claim 1, further comprising displaying a warning message or automatically canceling selection of a key including a previously-selected character to return to an initial key input state, when a key other than the sequence key is inputted.

7. The method of claim 1, further comprising mapping characters mapped to the selected key in one-to-one correspondence with the sequence key to display the characters at selected positions on a display screen of the mobile communication terminal, when the key containing the desired character is selected.

8. An apparatus for inputting characters in a mobile communication terminal in which at least one character is mapped to each key, the apparatus comprising:
a keypad for inputting an input key and sequence keys; and
a controller for selecting a character mapped to the sequence key from among characters mapped to the input key.

9. The apparatus of claim 8, further comprising a display unit for displaying the characters mapped to the input key and the sequence keys such that the characters are mapped in one-to-one correspondence with the sequence keys.

10. A method for inputting characters in a mobile communication terminal, in which at least one character is mapped to each element of input means, the method comprising:
selecting an element including a desired character; and
selecting a sequence element corresponding to the desired character.

11. The method of claim 10, further comprising the step of displaying the character designated by the selected sequence element.

12. The method of claim 10, wherein the element including the mapped character is displayed on a display unit of the mobile communication terminal using an on-screen keyboard, and the sequence element is changeable by a user's selection.

13. The method of claim 10, further comprising displaying a representative of characters included in the selected element, when a element other than the sequence key is inputted.

14. The method of claim 13, wherein the representative character is designated by a user.

15. The method of claim 10, further comprising displaying a warning message or automatically canceling selection of a element including a previously-selected character to return to an initial element input state, when a element other than the sequence element is inputted.

16. The method of claim 10, further comprising mapping characters mapped to the selected element in one-to-one correspondence with the sequence element to display the characters at selected positions on a display screen of the mobile communication terminal, when the element containing the desired character is selected.

17. A mobile communication terminal comprising:
a input means including an input element and sequence elements; and
a controller for selecting a character mapped to the sequence element from among characters mapped to the input element.

18. The mobile communication terminal of claim 17, further comprising a display unit for displaying the characters mapped to the input element and the sequence elements such that the characters are mapped in one-to-one correspondence with the sequence elements.
